(19) United States
(12) Patent Application Publication
(10) Pub. No.: US 2009/0320660 A1
(43) Pub. Date: Dec. 31, 2009

(54) METHOD FOR PRODUCING AT LEAST ONE WINDOW OPENING IN AN ELONGATE PAPER SUBSTRATE, AND APPARATUS

(76) Inventors: Michael Gwosdz-Kaupmann, Zirndorf (DE); Georg Kaluza, Lauf (DE); Reinwald Mitsam, Langenzenn (DE)

Correspondence Address: HOFFMANN & BARON, LLP, 6900 JERICHO TURNPIKE, SYOSSET, NY, 11791, US

(21) Appl. No.: 12/309,962

(22) PCT Filed: Jul. 27, 2007
(86) PCT No.: PCT/EP2007/006686

§ 371 Date: Mar. 9, 2009

(30) Foreign Application Priority Data
Aug. 9, 2006 (DE) 10 2006 037 432.0

(51) Int. Cl. B65H 35/00; B26D 3/00; B26D 5/30

(52) U.S. Cl. 83/40; 226/1; 226/2; 83/73

(57) ABSTRACT

The invention concerns a method of and an apparatus for producing at least one window opening (7) in an elongate paper substrate (1) which is virtually subdivided into paper sheet portions transversely with respect to its longitudinal axis. The method includes the following steps:
a) the paper substrate (1) is provided with at least one water mark (2) per paper sheet portion;
b) the position of at least one water mark (2) on the paper substrate (1) is detected by means of at least one sensor unit (3); and
c) the paper substrate (1) is now fed to a unit for producing openings in the paper substrate (1), which unit is actuated in such a way that at least one window opening (7) is produced per paper sheet portion in the paper substrate (1) on the basis of the position of the at least one water mark (2), that is detected by the at least one sensor unit (3).

The invention concerns a method of producing at least one window opening in an elongate paper substrate which is virtually divided into paper sheet portions transversely with respect to its longitudinal axis, and an apparatus for carrying out the method. Paper substrates with at least one window opening are used for the production of security or value-bearing documents such as bank notes, identity cards or passes, passports, IC cards, driving licenses or the like. In that case the at least one window opening is frequently covered with a film element which for example has reflective and/or transmissive security elements such as diffractive structures, holograms, Kinegrams®, printed images and the like, as well as optically variable substances such as luminescent materials, photochromic or thermochromic materials, liquid crystals, interference pigments, magnetic substances or the like.

WO 95/10420 A1 describes a process for producing at least one window opening in an elongate paper substrate. In that case window openings are introduced into the paper substrate by means of stamping or a laser. There is no description of the way in which the stamping tool or the laser is positioned on the paper substrate.

The paper substrate however is usually transported into a printing mechanism and printed upon with position marks to permit positioning of the stamping tool.

DE 101 63 381 A1 discloses a method in which window openings are already produced in the paper substrate, in production of the paper. The wet paper web however has a tendency to distortion so that precise positioning of the window openings is not possible or is only limitedly possible.

Round screen cylinder machines or Fourdrinier machines are suitable for the production of elongate paper substrates with water marks. When using a round screen cylinder machine a water mark is generated by a closed region in the screen while when using a Fourdrinier machine a pattern is pressed into the paper fiber suspension by means of a dandy roller to produce a water mark.

In the case of round screen machines, depending on the respective size of the machine, a plurality of equal portions, the so-called register lengths, within which in each case at least one water mark and possibly at least one further decorative water mark are formed, are arranged at the screen periphery. As a result substantially the deviations in the position of the water mark from the target location are respectively repeated after a screen revolution.

When using a flat screen it is also divided into a plurality of equal portions, the so-called register lengths, wherein within each register length at least one respective water mark and possibly at least one further decorative water mark is formed. As a result in this case also essentially the deviations in the position of the water marks from the target location are respectively repeated after a screen print, but here the deviations in each new screen start are also added.

Now the object of the invention is to provide an improved method of producing window openings in an elongate paper substrate and an apparatus for carrying out the method.

The object is attained by the method of producing at least one window opening in an elongate paper substrate which is virtually subdivided into paper sheet portions transversely with respect to its longitudinal axis, including the following steps:

a) the paper substrate is provided with at least one water mark per paper sheet portion;

b) the position of at least one water mark on the paper substrate is detected by means of at least one sensor unit; and

c) the paper substrate is now fed to a unit for producing openings in the paper substrate, which unit is actuated in such a way that at least one window opening is produced per paper sheet portion in the paper substrate on the basis of the position of the at least one water mark, that is detected by the at least one sensor unit.

The method according to the invention makes it possible to use at least one position mark which is already inexpensively formed in manufacture of the paper, in the form of at least one water mark per paper sheet portion, for positioning the at least one window opening on the paper substrate. The hitherto usual operation of printing position markings on the substrate is thus avoided. If the production of the at least one window opening in the paper substrate occurs at a moment in time at which the paper substrate is already present in dry form and stable in respect of shape, any displacement of the positions of window openings relative to each other is extensively excluded.

For the apparatus for carrying out the method the object is attained in that the apparatus has the following components:
a transport unit for transporting the elongate paper substrate;
a sensor unit for detecting the position of at least one water mark in the form of position data;
a computing unit for correcting the detected position data by means of an algorithm;
a unit controllable by means of the computing unit for producing the at least one window opening per paper sheet portion and optionally at least one control opening per paper sheet portion.

A water mark which is to be seen in the paper substrate in the form of a denser or darker or thinner or lighter location does not usually have a sharp edge boundary by virtue of the fiber structure of the paper substrate. The degree of the perceptible darker or lighter coloration of the paper substrate in the region of a water mark is also different in each water mark and moreover viewed over the surface of each water mark as the paper fibers are arranged differently in each respective case. The shape and size of an individual water mark as well as the spacing of a plurality of water marks relative to each other can also not be directly predicted as manufacture of the paper frequently involves distortion of the paper substrate while it is still moist and is not yet stable in respect of shape.

In particular it has therefore proven desirable if in method step (b) the position of at least one, in particular at least two, water marks is detected by means of the at least one sensor unit, in particular in the form of position data and optionally the detected position data are converted into corrected position data by means of an algorithm.

Furthermore it has proven desirable if in method step c) the unit for producing openings in the paper substrate produces at least one control opening and in register relationship therewith the at least one window opening per paper sheet portion in the paper substrate, on the basis of the position, detected by the at least one sensor unit, of the at least one water mark, in particular on the basis of the corrected position data of at least two water marks.

The at least one control opening, in comparison with a water mark, has the advantage of accurate positioning, a high degree of edge sharpness and an arrangement in register relationship with respect to the at least one window opening so that subsequent method steps such as a printing operation or a film application procedure are preferably controlled based on the at least one control opening.

The transport unit guides the paper web to the sensor unit and, preferably without interruption, to the unit for producing the openings in the paper substrate, wherein orientation and/or correction of the position of the paper web in regard to the unit for producing the openings in the paper substrate is effected so that the at least one window opening can be stamped in the paper web in the correct position.

It is preferred for the method according to the invention if in method step a) provided in the edge region of each paper sheet portion is the at least one water mark which is arranged on a first straight line parallel to the longitudinal axis of the paper substrate, in method step b) the position of at least one water mark is optically detected by means of the at least one sensor unit, and in method step c) the unit for producing openings in the paper substrate, on the basis of the corrected position data, produces at least one control opening and in register relationship therewith the at least one window opening per paper sheet portion in the paper substrate, wherein the at least one control opening is arranged on a second straight line which is oriented parallel to the first straight line in the edge region of the respective paper sheet portion.

It is further preferred for the method according to the invention if in method step a) provided in the edge region of each paper sheet portion are at least two water marks which are both arranged along a first straight line or respectively arranged on a first straight line which is/are oriented parallel to the longitudinal axis of the paper substrate.

It is further preferred for method step c) if the unit for producing openings in the paper substrate, on the basis of the corrected position data, produces at least two control openings and in register relationship therewith the at least one window opening per paper sheet portion in the paper substrate, wherein the at least two control openings are arranged on at least one second straight line which is oriented parallel to the first straight line in the edge region of the respective paper sheet portion.

In regard to the correction of the position data, positioning of the water mark on the first straight line at a given spacing from the edge of the paper substrate or the water marks in a row on the first straight line and at the most uniform possible spacing relative to each other is assumed to apply. The position data corrected in that way are used for controlling subsequent processing steps or stations of the apparatus such as the stamping unit.

It has proven desirable if the unit for producing the openings includes a control member for orientation and/or correction of a position of the elongate paper substrate relative to that unit. In that respect on the one hand the position and/or the speed of a tool for producing the openings can be controlled. Optionally correction of the position and/or the transport speed of the paper substrate can also be effected. Furthermore it is possible to control both the position and/or speed of the tool and also to change the position and/or transport speed of the paper substrate.

When processing a paper substrate which was formed on a round screen machine, the basis used for the control procedure is preferably a reference value for a register length which is based on a mean value which is calculated on the basis of the number of register lengths per screen periphery. Correction of that reference value is effected by preferably optical detection of at least one water mark per screen periphery, preferably precisely one water mark per screen periphery, while in addition a regulating tolerance in respect of the unit for producing the openings is also to be taken into account.

It has proven desirable if the unit for forming the at least one window opening and optionally the at least one control opening is formed by a stamping unit, in particular a rotating stamping cylinder, a laser cutting unit or a water jet cutting unit. In that respect for example the spacings between control openings which are formed, the control openings and the at least one window opening and between individual window openings are predetermined when using a stamping cylinder and are continuously repeated in accordance with the periphery of the stamping cylinder. In that respect the position of the stamping cylinder and the speed of rotation thereof can be controlled. It is however equally possible to use a non-rotating stamping tool.

The at least one sensor unit is preferably a sensor unit for optical detection of the position of the at least one water mark and is preferably formed by a camera system. The transport unit, for processing paper webs from roll to roll, is preferably formed by a pulling mechanism, a rolling gap or the like. The apparatus further preferably has at least one printing mechanism for printing on the paper substrate, which is arranged upstream and/or downstream of the unit for producing openings in the paper substrate. In addition it has proven desirable if the apparatus has at least one film application unit disposed downstream of the unit for producing openings in the paper substrate.

The paper substrate is subdivided in particular into at least two paper sheet portions each having at least one respective panel and there is at least one respective water mark per paper sheet portion. The paper sheet portions are therefore arranged in succession when viewed in the longitudinal direction of the paper substrate.

It is further advantageous if the at least two paper sheet portions are respectively subdivided into at least two sub-segments or panels, wherein each sub-segment is provided with at least one window opening. Thus as viewed in the longitudinal direction of the paper substrate the sub-segments are arranged in mutually juxtaposed relationship and/or in succession. Division of the paper substrate into panels is a procedure which is usual in the printing art in order to utilize the available paper substrate in as optimum a fashion as possible for forming many similar documents (“ganging up”).

It has proven desirable if the paper substrate is subdivided by computation, that is to say only virtually, into the paper sheet portions, or paper sheet portions and sub-segments, wherein after carrying out all method steps on the paper substrate or finishing of the panels, a cutting unit is arranged, which cuts up the paper substrate into the individual panels to produce individual security documents.

The elongate paper substrate preferably occurs in the form of being wound up as a roll material. The paper substrate is preferably cut up into the panels after the formation of the openings and optionally further process steps such as a printing operation, an application of security elements in particular in the region of the window opening, or lamination thereon of one or more film layers, so that simultaneous production of a large number of similar security documents including window openings such as bank notes, identity cards or passes, driving licenses and so forth can be inexpensively implemented.

Alternatively subdivision into paper sheet portions and sub-segments can be effected by perforation or initial stamping in the paper substrate. That however can adversely affect processability of the paper substrate from roll to roll.

It is preferable for at least two window openings to be formed in the paper substrate and for the at least two window openings to be arranged on at least one third straight line oriented parallel to the first and the second straight lines.

Preferably the at least one water mark is formed with a respective length and a width in the range of between about 0.5 and 10 mm, in particular in the range of between 1 and 5 mm. In that case the choice of the suitable dimensions of a water mark is in particular dependent on the sensor unit used for detecting the position of the water marks, the prevailing illumination conditions and the contrast between the water marks and the remaining paper material. A lighting means is possibly to be provided on the rear side of the paper substrate to enhance the contrast between the water marks and the remaining paper material and to facilitate detection of the position of a water mark by the sensor unit.

It has proven desirable if each water mark at least touches the first straight line. It will be noted however that, with a large number of water marks which are taken into consideration to ascertain the corrected position data, it can happen that one or more water marks do not touch the first straight line. In regard to the usual paper production methods, the position of the water marks can deviate in the millimeter range from the desired position according to the round screen or the long Fourdrinier screen.

It has proven to be advantageous if the at least one water mark is of a point-shaped or line-shaped configuration. Furthermore it has proven desirable if a respective control opening is associated with each water mark, in particular if a respective control opening is formed beside each water mark. A respective control opening can be formed in the region of each water mark so that at least parts of the respective water mark are removed.

It has proven desirable if in addition to the at least one water mark the paper substrate is provided with at least one decorative water mark. Such decorative water marks are usual in particular in relation to bank notes or security documents such as identity cards or passes, certificates and so forth and show people, coats of arms, patterns, text or similar. Preferably at least one decorative water mark is provided per panel.

The edge region of the paper substrate including the at least one control opening and the at least one water mark is cut off, preferably in the cutting unit, after formation of the at least one window opening and possibly further process steps or after finishing thereof.

In regard to rapid inexpensive processing of the elongate paper substrate it has proven desirable if the elongate substrate is transported during the optical detection of the position of the at least one water mark and during the formation of the at least one control openings and the at least one window opening in the form of a paper web from roll to roll. The paper substrate including the at least one water mark and optionally additional decorative water marks is drawn off a supply roll, fed by means of the transport unit to the sensor unit for detection of the position of the at least one water mark, to the unit for producing the openings and optionally to further units for applying printing, applying film elements or similar, and is wound onto a supply roll again. Alternatively instead of being wound onto a supply roll the paper substrate is divided into the panels, in particular into security or value-bearing documents.

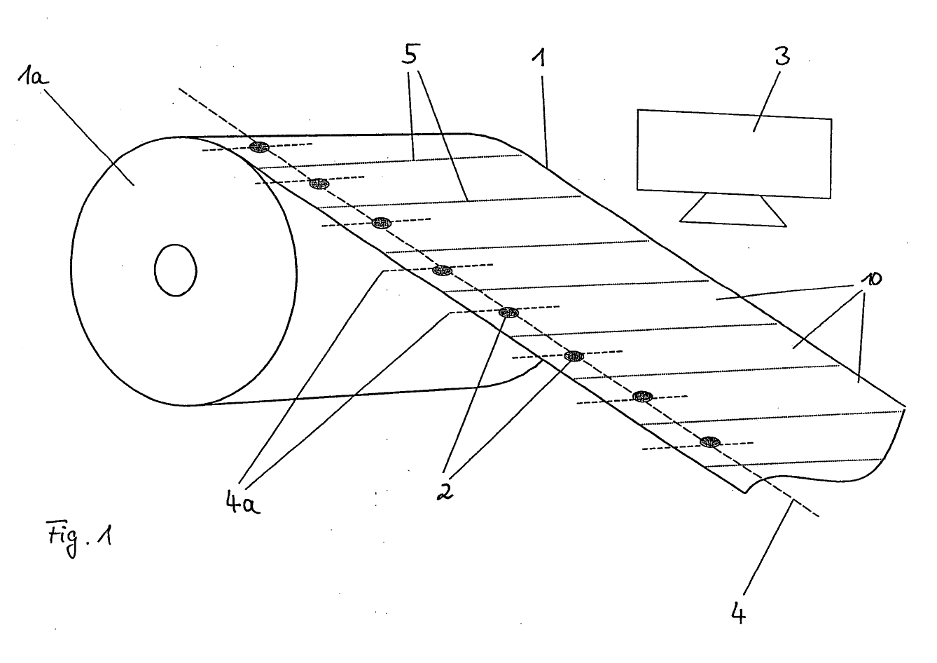

FIGS. 1 through 4 are intended to describe the method according to the invention and the apparatus according to the invention, by way of example. In the drawing:

FIG. 1 diagrammatically shows an elongate paper substrate subdivided into paper sheet portions, with a respective water mark per paper sheet portion,

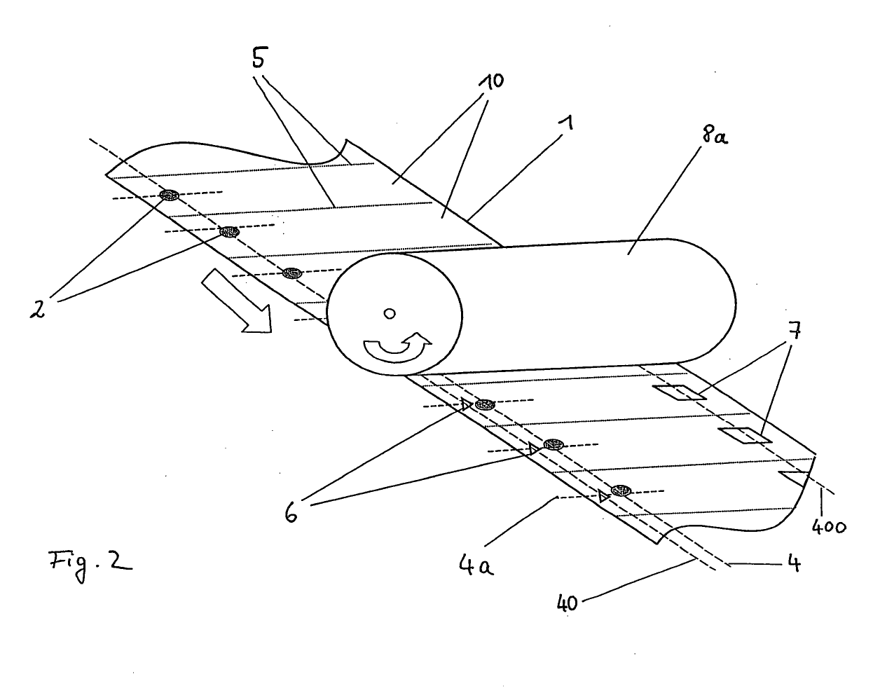

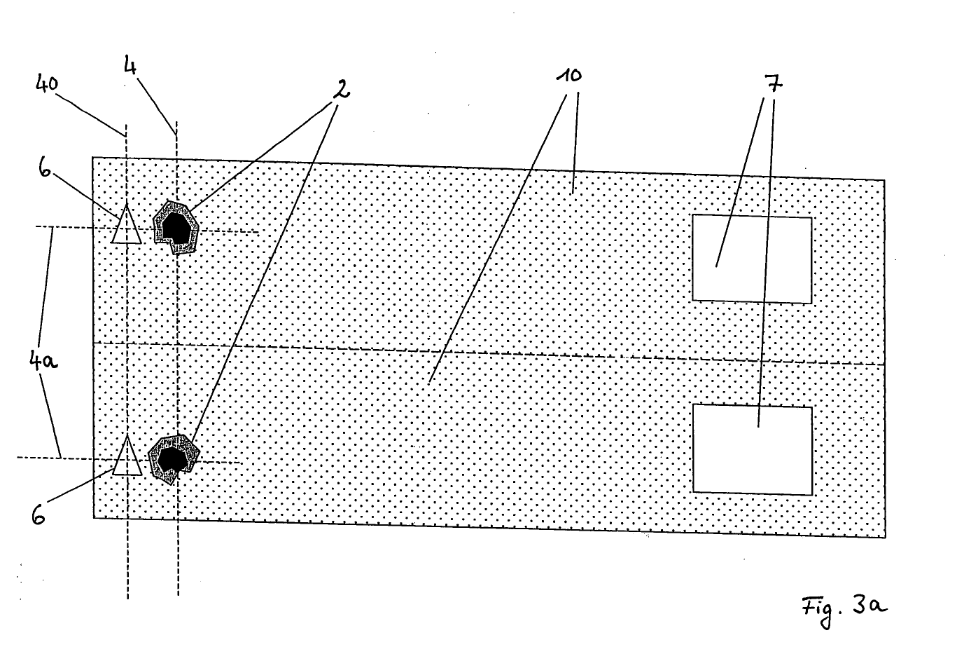

FIG. 2 diagrammatically shows the paper substrate of FIG. 1 in processing in a stamping unit,

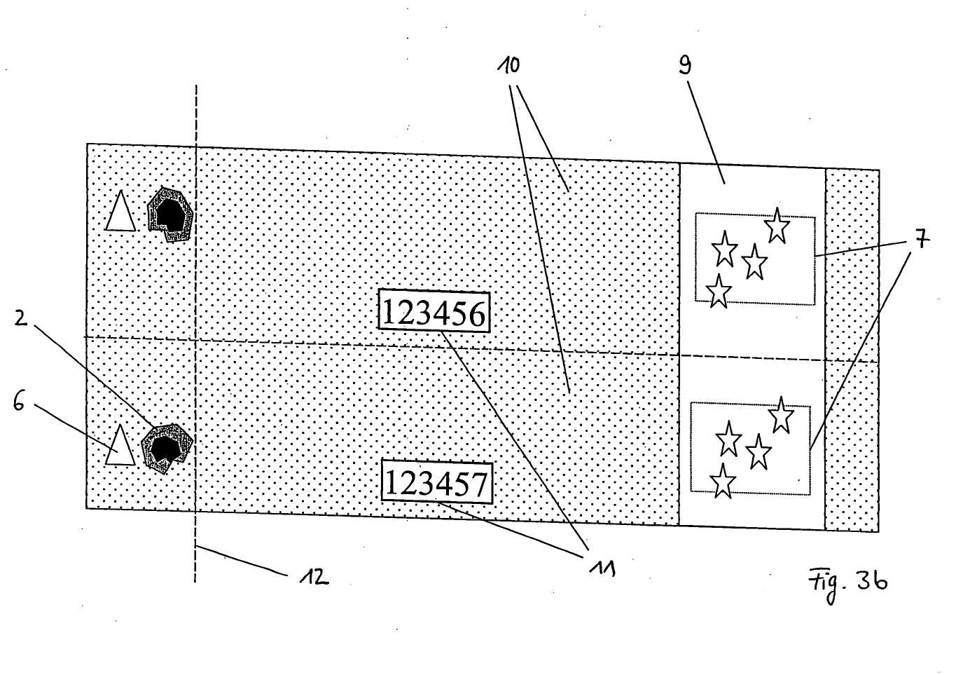

FIG. 3a shows a plan view of two paper sheet portions of a paper substrate, wherein there is a water mark and a control opening per paper sheet portion,

FIG. 3b shows the paper sheet portions of FIG. 3a after a film application step and a printing step,

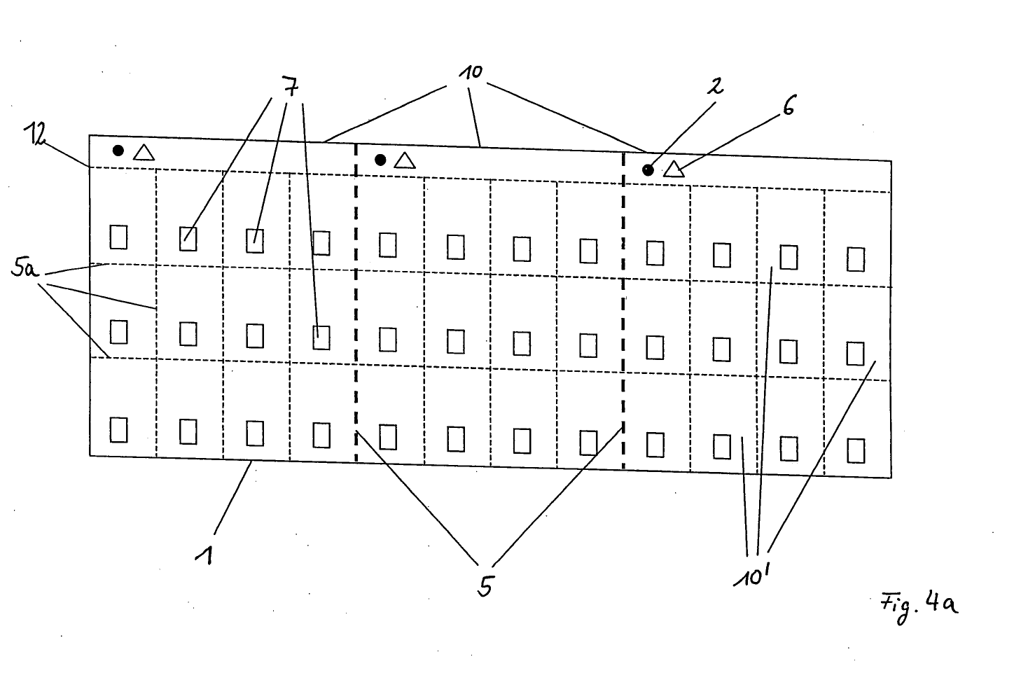

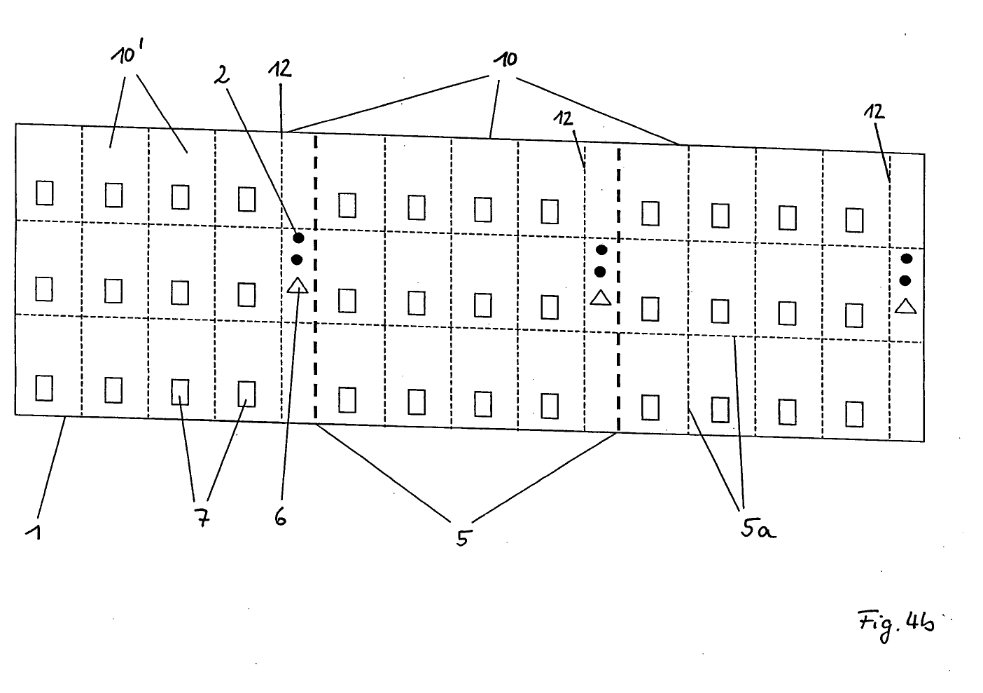

FIGS. 4a and 4b show a plan view of paper substrate virtually subdivided into panels, and

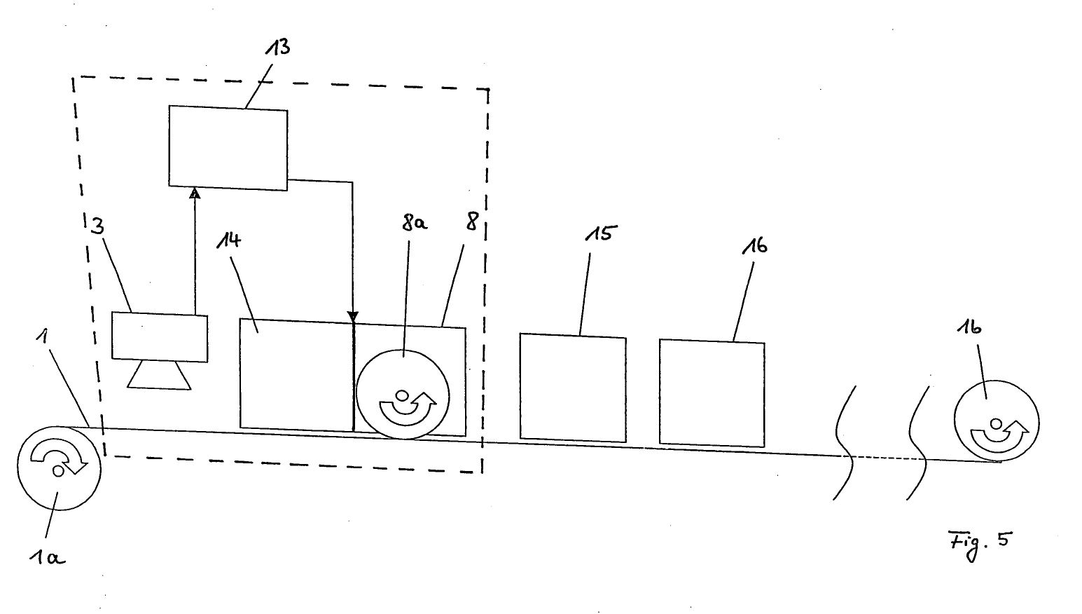

FIG. 5 diagrammatically shows an apparatus for carrying out the method.

FIG. 1 diagrammatically shows an elongate paper substrate 1 subdivided into paper sheet portions 10, with a respective water mark 2 per paper sheet portion 10. The paper substrate 1 is wound onto a roll 1a and is drawn therefrom for further processing. Subdivision of the paper substrate 1 into paper sheet portions 10 is effected virtually by division lines 5 disposed between two adjacent paper sheet portions 10. A sensor unit 3, for example a camera system, optically detects the position of the water marks 2 and the position thereof relative to each other on the paper substrate 1. As the position, shape, size and contrast of each water mark 2 are slightly different, the position data detected by the sensor unit 3 are only guideline values which must be suitably corrected so that they can be used as control markings for further process steps. Thus in particular correction is effected in respect of the spacings between the water marks 2, and optionally also correction in respect of the edge spacing.

By virtue of the relatively great distortion of the paper substrate it has proven worthwhile in practice if it is not each individual water mark but only one water mark per screen periphery or screen length of the paper making machine, that is detected. If for example 8 register lengths each having a respective water mark are arranged on the periphery of a round screen, only each eighth water mark is detected and used for control purposes.

The position data ascertained by the sensor unit 3 are passed for that purpose to a computing unit (not shown here) which calculates corrected position data by means of an algorithm. In that case the computing unit takes account at least of the positions of a water mark 2 per screen periphery or screen length of the paper making machine. In that respect the spacing of the water mark 2, in relation to a long side of the paper substrate 1, is corrected by computation, insofar as a first straight line 4 is drawn by computation parallel to a long side of the paper substrate 1 through or adjoining the water mark 2 and the position of all subsequent water marks 2 per screen periphery or screen length of the paper making machine is assumed to be on that first straight line 4. The position of the water marks 2 can further be corrected by computation, in regard to their spacing relative to each other. In that case, a spacing which is as constant as possible is calculated, at least per screen periphery or screen length of the paper making machine. The corrected position data for the respective water mark 2 are accordingly afforded, at least for a given portion of the paper substrate, as the point of intersection between the first straight line 4 and an auxiliary straight line 4a, wherein the auxiliary straight lines 4a are calculated at a spacing relative to each other which is as constant as possible and perpendicularly to the first straight line 4 in the plane of the paper substrate 1 in accordance with the detected position data. The paper sheet portions 10 can be subdivided into sub-segments or further panels by means of further virtual division lines which can be provided parallel to the first straight line 4 and to the auxiliary straight line 4a in the paper substrate 1 (see FIGS. 4a and 4b).

FIG. 2 diagrammatically shows the paper substrate 1 of FIG. 1 upon processing in a unit in the form of a stamping unit for producing openings in the paper substrate, all that is shown of a stamping unit here being the stamping tool in the form of a stamping cylinder 8a. The paper substrate 1 is oriented relative to the position of the stamping cylinder 8a on the basis of the position data corrected in the computing unit, so that control openings 6 and window openings 7 are formed in register relationship with each other and with respect to the corrected position data of the water marks 2. In that case, beside each water mark 2, a respective control opening 6 is stamped in the paper substrate 1, the control openings 6 being on a second straight line 40 parallel to the first straight line 4 and on a respective auxiliary straight line 4a. The window openings 7 are on a third straight line 400 parallel to the second straight line 40.

FIG. 3a shows two paper sheet portions 10 of a paper substrate as a plan view, with a respective water mark 2 and a control opening 6 being provided on a paper sheet portion 10. It can be clearly seen at the water marks 2 that the contrast thereof relative to the paper material of the paper sheet portion 10, shape, size and position is different. The first straight line 4 intersects both water marks 2 and corrects or standardizes the spacing of each water mark 2 relative to the parallel edge of the paper sheet portion 10, to the spacing of the first straight line 4 relative to the parallel edge of the paper sheet portion 10. The auxiliary straight lines 4a correct or standardize the spacing between the two water marks 2. The corrected position of each water mark 2 is accordingly at the point of intersection of the first straight line 4 and an auxiliary straight line 4a. The control openings 6 and the two window openings 7 are formed in conformity with those corrected position data. The control openings 6 are superior to the water marks 2 in regard to the capacity for reading off their position, by virtue of their more exact positioning, shape and edge sharpness, so that subsequent process steps are preferably controlled on the basis of the control openings 6.

FIG. 3b shows the paper sheet portions 10 of FIG. 3a, to which moreover a transparent film strip 9 which presents a star-shaped metal decoration with viewing angle-dependent optical effect was applied by means of lamination and on which a respective print image 11 was formed in the form of a serial number. The window openings 7 were closed by means of the film strip 9. The positioning of the film strip 9 and the print images 11 in regard to the paper sheet portions 10 is effected in the laminating or printing operation in accordance with the position of the control openings 6 which are arranged in register relationship with the window openings 7 (here covered by film strip 9 and indicated by dotted lines), wherein optical position detection of the control openings 6 is effected.

After the implementation of all process steps on the paper substrate it is divided in the region of the division lines 5 (see FIGS. 1 and 2) and the edge region including the water marks 2 and the control openings 6 is removed, by a cut being made on a severing line 12 (see FIG. 3b).

FIG. 4a shows three paper sheet portions 10 of a paper substrate 1 as a plan view, which are virtually divided from each other by means of the division lines 5, wherein a water mark 2 and a control opening 6 are provided on each of the three paper sheet portions 10 in the edge region. Each paper sheet portion 10 is in turn subdivided by means of virtual division lines 5a into twelve sub-segments 10′ or panels. The window openings 7 are formed in each sub-segment 10′, in register relationship with the control openings 6. The edge region of the paper substrate 1 including the water marks 2 and the control openings 6 is cut off after the sub-segments 10′ are finished along the severing line 12 and discarded. The sub-segments 10′, after they are finished, are also cut up separately, along the division lines 5, 5a.

FIG. 4b also shows a plan view of three paper sheet portions 10 of a paper substrate 1, which are virtually separated from each other by means of the division lines 5, wherein two water marks 2 and a control opening 6 are provided on each of the three paper sheet portions 10 in the edge region. Each paper sheet portion 10 is again subdivided by means of virtual division lines 5a into twelve sub-segments 10′ or panels. The window openings 7 are formed in each sub-segment 10′ in register relationship with the control openings 6. The edge region of each paper sheet portion including the water marks 2 and the control openings 6 is cut off, after the sub-segments 10′ are finished, along the severing lines 12, and discarded. After the sub-segments 10′ are finished they are also cut up separately along the division lines 5, 5a.

FIG. 5 diagrammatically shows an apparatus for carrying out the method. It has a supply roll 1a on which the elongate paper substrate 1 is wound. The paper substrate 1 is fed, from the supply roll 1a, to a unit for producing openings in the paper substrate (see the broken line) which includes a sensor unit 3 in the form of a camera system which detects the position of water marks on the paper substrate 1 and communicates that to a computing unit 13. The computing unit 13 ascertains position data which are corrected by means of an algorithm from the detected position data and on the basis of the corrected data passes a control signal to a stamping unit 8 which includes a control member 14 for controlling the speed of rotation of the stamping cylinder 8a and optionally the position thereof or the speed of transport and optionally the position of the paper substrate (1). The control member 14 controls the position of the paper substrate 1 and in particular the paper sheet portions in the plane of the paper substrate 1 relative to the position of the stamping cylinder 8a and the cutting units (not shown here) arranged thereon, for producing the control and window openings in the paper substrate 1.

The paper substrate 1 is transported into the unit for producing the openings and, after implementation of position correction, the stamping operation is carried out, by the control and window openings being produced by means of the stamping cylinder 8a.

Finally the paper substrate 1 is fed to a printing mechanism 15 and printed upon with colored patterns and serial numbers. The control openings formed in the stamping unit 8 are used to control the printing mechanism 15.

The printed paper substrate 1 is now transported into a film application unit 16 and the window openings are respectively closed with a film element. The control openings formed in the stamping unit 8 are again used to control the film application unit 16.

There can then follow further processing stations, for example a further printing mechanism, a vapor deposition installation, a further film application unit and so forth, which however are not shown here. Finally the finished paper substrate 1 is wound onto a roll 1b or alternatively fed to a cutting unit in order to cut up the paper substrate into the panels along the virtual dividing lines. The edge region containing the water marks and the control openings is cut off.

The man skilled in the art with knowledge of the method according to the invention and the apparatus suitable for carrying out the method is readily in a position to process paper substrates with water marks directly in units for producing openings in the paper substrate and to carry out inline processing, that is to say without intermediate storage of the paper substrate, starting from that unit in register relationship with further process stations such as the film application unit, the printing mechanism, a PVD or CVD unit, an embossing unit and so forth.

1-28. (canceled)

29. A method of producing at least one window opening in an elongate paper substrate which is virtually subdivided into paper sheet portions transversely with respect to its longitudinal axis, including the following steps:
a) the paper substrate is provided with at least one water mark per paper sheet portion;
b) the position of at least one water mark on the paper substrate is detected by means of at least one sensor unit, wherein the position of the at least one water mark per paper sheet portion is detected by means of the at least one sensor unit in the form of position data and the detected position data are converted into corrected position data by means of an algorithm; and
c) the paper substrate is now fed to a unit for producing openings in the paper substrate, which unit is actuated in such a way that at least one window opening is produced per paper sheet portion in the paper substrate on the basis of the position of the at least one water mark, that is detected by the at least one sensor unit.

30. A method as set forth in claim 29, wherein, in method step b), the position of at least two water marks on the paper substrate is detected.

31. A method as set forth in claim 29, wherein, in method step c), the unit for producing openings in the paper substrate produces at least one control opening and in register relationship therewith the at least one window opening per paper sheet portion in the paper substrate, on the basis of the position, detected by the at least one sensor unit, of the at least one water mark, or on the basis of the corrected position data.

32. A method as set forth in claim 29, wherein the elongate paper substrate,
in method step a),
provided in the edge region of each paper sheet portion is the at least one water mark which is arranged on a first straight line parallel to the longitudinal axis of the paper substrate,
in method step b),
the position of at least one water mark is optically detected by means of the at least one sensor unit, and
in method step c),
the unit for producing openings in the paper substrate, on the basis of the corrected position data, produces at least one control opening and in register relationship therewith the at least one window opening per paper sheet portion in the paper substrate, wherein the at least one control opening is arranged on a second straight line which is oriented parallel to the first straight line in the edge region of the respective paper sheet portion.

33. A method as set forth in claim 32, wherein the elongate paper substrate,
in method step a),
provided in the edge region of each paper sheet portion are at least two water marks which are both arranged along a first straight line or respectively arranged on a first straight line which is/are oriented parallel to the longitudinal axis of the paper substrate.

34. A method as set forth in claim 32, wherein
in method step c),
the unit for producing openings in the paper substrate, on the basis of the corrected position data, produces at least two control openings and in register relationship therewith the at least one window opening per paper sheet portion in the paper substrate, wherein the at least two control openings are arranged on at least one second straight line which is oriented parallel to the first straight line in the edge region of the respective paper sheet portion.

35. A method as set forth in claim 29, wherein the unit for forming the at least one control opening and/or the at least one window opening is formed by a stamping unit, a laser cutting unit or a water jet cutting unit.

36. A method as set forth in claim 29, wherein the paper substrate is subdivided into at least two paper sheet portions.

37. A method as set forth in claim 36, wherein the at least two paper sheet portions are respectively subdivided into at least two sub-segments, wherein each sub-segments is provided with at least one window opening.

38. A method as set forth in claim 32, wherein at least two window openings are formed and the at least two window openings are arranged on at least one third straight line oriented parallel to the first straight line and the second straight line.

39. A method as set forth in claim 29, wherein the at least two water marks are formed with a respective length and a width in the range of between 0.5 and 10 mm.

40. A method as set forth in claim 29, wherein each water mark at least touches the first straight line.

41. A method as set forth in claim 29, wherein each water mark is of a point-shaped or line-shaped configuration.

42. A method as set forth in claim 29, wherein a respective control opening is associated with each water mark.

43. A method as set forth in claim 42, wherein a respective control opening is formed beside each water mark.

44. A method as set forth in claim 43, wherein a respective control opening is formed in the region of each water mark so that at least parts of the respective water mark are removed.

45. A method as set forth in claim 29, wherein in addition to the at least one water mark, the paper substrate is provided with at least one decorative water mark.

46. A method as set forth in claim 29, wherein the elongate paper substrate having the at least one water mark is transported during the optical detection of the position of the at least one water mark and during the formation of the at least one control openings and the at least one window opening from roll to roll.

47. A method as set forth in claim 29, wherein, in step a), the paper substrate is provided in the edge region of the respective paper sheet portion with the at least one water mark.

48. Apparatus for carrying out a method as set forth in claim 29, comprising:
a transport unit for transporting the elongate paper substrate;
a sensor unit for detecting the position of at least one water mark in the form of position data;
a computing unit for correcting the detected position data by means of an algorithm; and
a unit controllable by means of the computing unit for producing the at least one window opening per paper sheet portion or the at least one window opening and the at least one control opening per paper sheet portion.

49. Apparatus as set forth in claim 48, wherein the unit includes a control member for orientation and/or correction of a position of the elongate paper substrate relative to the unit.

50. Apparatus as set forth in claim 48, wherein the unit is in the form of a stamping cylinder.

51. Apparatus as set forth in claim 48, wherein the at least one sensor unit is a sensor unit for optical detection of the position of the at least one water mark.

52. Apparatus as set forth in claim 51, wherein the at least one sensor unit is formed by a camera system.

53. Apparatus as set forth in claim 48, wherein the transport unit is formed by a pulling mechanism or a roll gap.

54. Apparatus as set forth in claim 48, wherein the apparatus further has at least one printing mechanism for printing on the paper substrate, which is disposed upstream and/or downstream of the unit.

55. Apparatus as set forth in claim 48, wherein the apparatus further has at least one film application unit disposed downstream of the unit.

56. Apparatus as set forth in claim 48, wherein the apparatus further has at least one cutting unit which is adapted to cut up the paper substrate into individual panels and/or to cut off the edge region of each paper sheet portion which has the at least one water mark and optionally the at least one control opening.
